(19) United States
(12) Patent Application Publication
(10) Pub. No.: US 2011/0268256 A1
(43) Pub. Date: Nov. 3, 2011

(54) Communication Apparatus, Programmable Device Incorporated in the Apparatus, and Method of Controlling Program Writing of the Device

(76) Inventor: Eiji Ootsuka, Kokubunji-shi (JP)

(21) Appl. No.: 13/080,554

(22) Filed: Apr. 5, 2011

(30) Foreign Application Priority Data
Apr. 30, 2010 (JP) 2010-105618

(51) Int. Cl. H04M 1/24

(52) U.S. Cl. 379/1.01

(57) ABSTRACT

According to one embodiment, a communication apparatus includes a communication module, a detecting module and a controlling module. The communicating module operates based on a program stored in storage, and executes communication with electronic equipment connected to a connection terminal. The detecting module detects that electronic equipment is connected to the connection terminal, at power-on. The controlling module executes an operation of writing a program possessed by the electronic equipment to the storage.

### CROSS-REFERENCE TO RELATED APPLICATIONS

This application is based upon and claims the benefit of priority from Japanese Patent Application No. 2010-105618, filed Apr. 30, 2010; the entire contents of which are incorporated herein by reference.

### FIELD

Embodiments described herein relate generally to a communication apparatus, which is used as a time switch of a telephone switching system, and performs communication based on a program stored in a storage, a programmable device incorporated in the communication apparatus, and a method of controlling program writing of the device.

### BACKGROUND

It is well known that a field programmable gate array (FPGA), which reads a program stored in a ROM at power-on, and forms a signal processing circuit such as a voice/image synthesis circuit and a watchdog timer by configuration according to the program, is used in various kinds of electronic equipment. For example, a telephone switching system using such an FPGA as a time switch is known.

For configuration with an FPGA, it is necessary to previously write a program to a configuration ROM to be used by the FPGA. For writing a program in a configuration ROM, it is necessary to previously write circuit data to a ROM, and mount the ROM at the time of manufacturing, or write the data by means of a JTAG terminal as an exclusive writing terminal.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram of a telephone switching system incorporating a communication apparatus as a time switch according to a first embodiment;

FIG. 2 is a block diagram of a concrete configuration of the time switch of the first embodiment;

FIG. 3 is a flowchart of control procedures of a configuration circuit when connecting a writing unit and a configuration ROM, in the first embodiment;

FIG. 4 is a perspective view showing an example of connecting a configuration ROM board for production of production equipment to a connector of an FPGA-mounted board, in a second embodiment;

FIG. 5 is a block diagram of a concrete configuration of a time switch according to the second embodiment;

FIG. 6 is a diagram showing a memory map used in the second embodiment;

FIG. 7 is a flowchart of control procedures of a writing circuit in the second embodiment;

FIG. 8 is a block diagram of a concrete configuration of a time switch according to a third embodiment;

FIG. 9 is a diagram showing header data handled in the third embodiment;

FIG. 10 is a flowchart of control procedures of a configuration circuit when connecting a ROM of production equipment and a configuration ROM, in the third embodiment; and

FIG. 11 is a timing chart for explaining the operation of a writing circuit, in the third embodiment.

### DETAILED DESCRIPTION

Various embodiments will be described hereinafter with reference to the accompanying drawings. In general, according to one embodiment, a communication apparatus includes a communicating module, a detecting module and a controlling module. The communicating module operates based on a program stored in storage, and executes communication with electronic equipment connected to a connection terminal. The detecting module detects that electronic equipment is connected to the connection terminal, at power-on, wherein the electronic equipment includes a program to be written to the storage. The controlling module executes an operation of writing a program possessed by the electronic equipment to the storage, when the electronic equipment connected to the connection terminal is detected.

### First Embodiment

In the first embodiment, a matrix switch directly connects a configuration ROM to a writing unit of production equipment, which writes a program to a configuration ROM of an FPGA provided in a communication apparatus.

For writing a configuration ROM, it is necessary to previously write circuit data to a ROM and mount the ROM at the time of manufacturing, or write the data by mans of a JTAG terminal as an exclusive writing terminal. If a ROM storing circuit data is mounted, when a program is changed by a bug, the mounted ROM must be abandoned, and a new ROM must be mounted. If a JTAG terminal is used, it is common to write a program by means of writing software supplied by an FPGA vendor and exclusive download cable, or by a general-purpose JTAG unit. This requires to install necessary equipment, and to provide a connector in a product. This increases the cost of product. Moreover, a JTAG unit cannot write data at high speed.

Usually, when equipment is installed according to the scale of production, the product cost is affected by the number of man-hours to operate the equipment and the installation cost. Further, writing a program to a small-lot product unexpected to have the mass-production effect is difficult considering the influence of the equipment cost upon the product cost.

The embodiment realizes a simple low-cost apparatus configured to write a program to storage at high speed by the less number of man-hours.

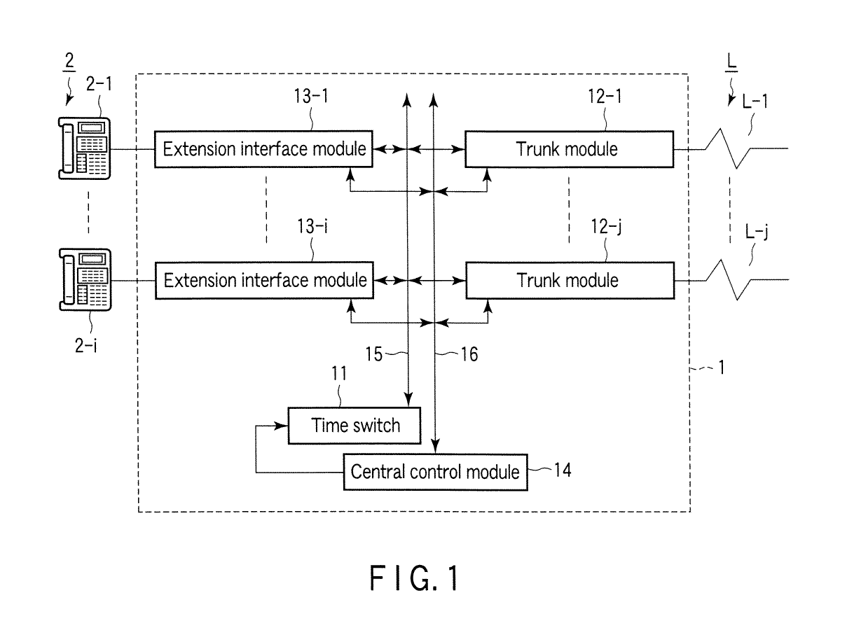

FIG. 1 is a block diagram of a telephone switching system incorporating a communication apparatus as a time switch according to the first embodiment.

In the telephone switching system, as shown in the drawing, a plurality (maximum i sets) of extension terminals 2 (2-1 to 2-i) are optionally connected to a telephone exchange apparatus 1. The extension terminal 2 employs an analog telephone set or a key telephone set.

The telephone exchange apparatus 1 further comprises a time switch 11, a plurality (j sets) of trunk modules 12 (12-1 to 12-j), a plurality (i sets) of extension interface modules 13 (13-1 to 13-I), and a central control module 14. The time switch 11, trunk module 12, and extension interface module 13 are connected via a PCM highway 15.

The trunk module 12, extension interface module 13, and central control module 14 are connected via a data highway 16.

The time switch 11 is operated to establish a communication path between the trunk module 12 and extension interface module 13 via the PCM highway 15, under the control of the central control module 14.

The trunk module 12 is connected to a trunk L (L−1 to L−j) such as a pubic line and a leased line, if necessary. The trunk module 12 offers an interface with the connected trunk L. The trunk module 12 sends/receives various control data related to the trunk, to/from the central control module 14, via the data highway 16.

The extension interface module 13 is connected to the extension terminal 2, if necessary. The extension interface module 13 offers an interface with the connected extension terminal 2. The extension interface module 13 transfers various control data related to the leaded line interface, to the central control module 14 via the data highway 16.

The central control module 14 generally controls the time switch 11, trunk module 12, and extension interface module 13, and realizes operation as the telephone exchange apparatus 1. For example, the central control module 14 originates a call in response to a call request from each of the extension terminals 2-1 to 2-i, terminates an incoming outside call from the trunk L, and transfers a call between the extension terminals 2-1 to 2-i.

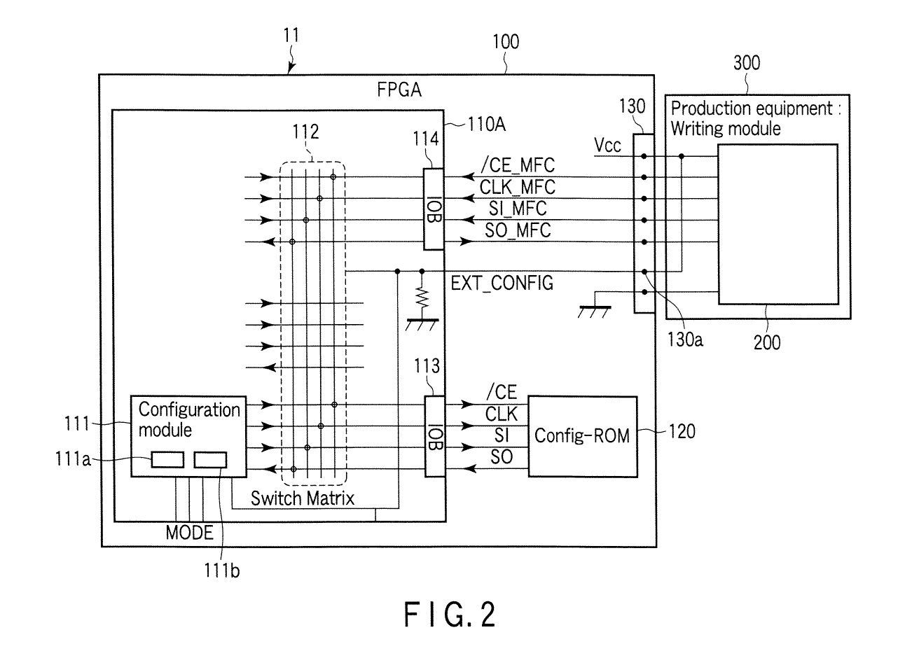

In the first embodiment, the time switch 11 is realized by configuration with an FPGA. FIG. 2 is a block diagram of a concrete configuration of the time switch 11.

In the time switch 11, an FPGA 110A, a configuration ROM 120, and a connector 130 to connect an external device are mounted on a board 100. The configuration ROM 120 stores a program to realize operation as the time switch 11.

The FPGA 110A comprises a configuration module 111, a matrix switch 112, and input/output modules 113 and 114. The input/output module 113 is a connection terminal for transferring a signal with the configuration ROM 120. The input/output module 114 is a connection terminal for transferring a signal with electronic equipment connected to the connector 130.

The configuration module 111 reads a program from the configuration ROM 120 connected via the matrix switch 112 and input/output module 113, and performs configuration based the program, thereby forming the time switch 11. The configuration module 111 is provided with a detector 111a and a controller 111b.

When a program write request (EXT CONFIG) is received from a writing module 200 of production equipment via an external configuration terminal 130a of the connector 130, the detector 111a detects that the writing module 200 is connected to the connector 130.

When the detector 111a detects the connection of the writing module 200 to the connector 130, the controller 111b controls the matrix switch 112 to directly connect the writing module 200 to the configuration ROM 120.

The connector 130 is usually connected to the PCM highway 15 and a control bus connecting the central control module 14. In the first embodiment, the connector 130 is used to connect not only the PCM highway 15 and control bus, but also the writing module 200.

Next, the operation of the above configuration is explained.

The configuration ROM 120 necessary for the FPGA 110A is connected to the input/output module 113 that is used as an exclusive terminal. A certain module has a function switched to an input/output module after configuration, but usable signals are limited to protect memory. Thus, it is necessary to separate from input/output signal terminal pins such as an external extension device and display/switch of a board provided in a product. An exclusive terminal needs to be installed on the board 100 for writing from the external writing module 200. This increases the cost of a product.

To realize an in-system program (ISP) which writes the configuration ROM 120 at high speed without affecting the product cost, the external configuration terminal 130a for setting a fixed connection to the matrix switch 112 in the FPGA 110A is provided, the fixed connection is executed by the data of this terminal, thereby forming a route able to connect a signal with an external terminal pin mounted in a product.

FIG. 3 is a flowchart of control procedures of the configuration module 111 when making connection between the writing module 200 and configuration ROM 120.

When a not-shown power switch is turned on and a not-shown power supply module supplies power, the configuration module 111 determines whether a write request is sent from the writing module 200 connected to the connector 130 (block ST3a). When a write request is received from the writing module 200 (Yes), the configuration module 111 controls the matrix switch 112 to directly connect the writing module 200 to the configuration ROM 120 (block ST3b).

On the other hand, when the writing module 200 is not detected via the external configuration terminal 130a after the power switch is turned on (No), the configuration module 111 determines that the connector 130 has been connected to the PCM highway 15 or control bus, for example, and executes configuration based on a program stored in the configuration ROM 120, thereby forming the time switch 11 (block ST3c). When the connector 130 is connected to the PCM highway 15 or control bus, for example, the external configuration terminal 130a is not connected to them.

When a program is written to the configuration ROM 120 by the above operation, it is conventionally necessary to provide an exclusive writing terminal on the board 100 in addition to the connector 130. In the first embodiment, all that is needed is to connect the writing module 200 to the connector 130. The writing module 200 can be a general-purpose personal computer connectable to the connector 130. This contributes to reduce the cost of production equipment.

As described above, in the first embodiment, only the FPGA 110A, configuration ROM 120, and connector 130 are provided on the board 100 of the time switch 11, an exclusive terminal for writing the configuration ROM 120 is shared by the connector 130 for connecting the PCM highway 15 and control bus. When a program is written to the configuration ROM 120, the configuration module 111 receives a write request from the writing module 200 connected to the connector 130, whereby the matrix switch 112 directly connects the writing module 200 to the configuration ROM 120.

Therefore, it is unnecessary to provide an exclusive writing terminal in addition to the connector 130, and a program can be written to the configuration ROM 120 at high speed with less number of man-hours. This makes the time switch 11 relatively simple and compact.

Further, in the first embodiment, the matrix switch 112 directly connects the writing module 200 to the configuration ROM 120, the configuration module 111 is not operated for writing a program, and the program writing time is reduced. This makes the apparatus applicable to a high-speed ISP.

### Second Embodiment

In a second embodiment, a writing circuit for a configuration ROM is provided in an FPGA, thereby reducing the cost of production equipment.

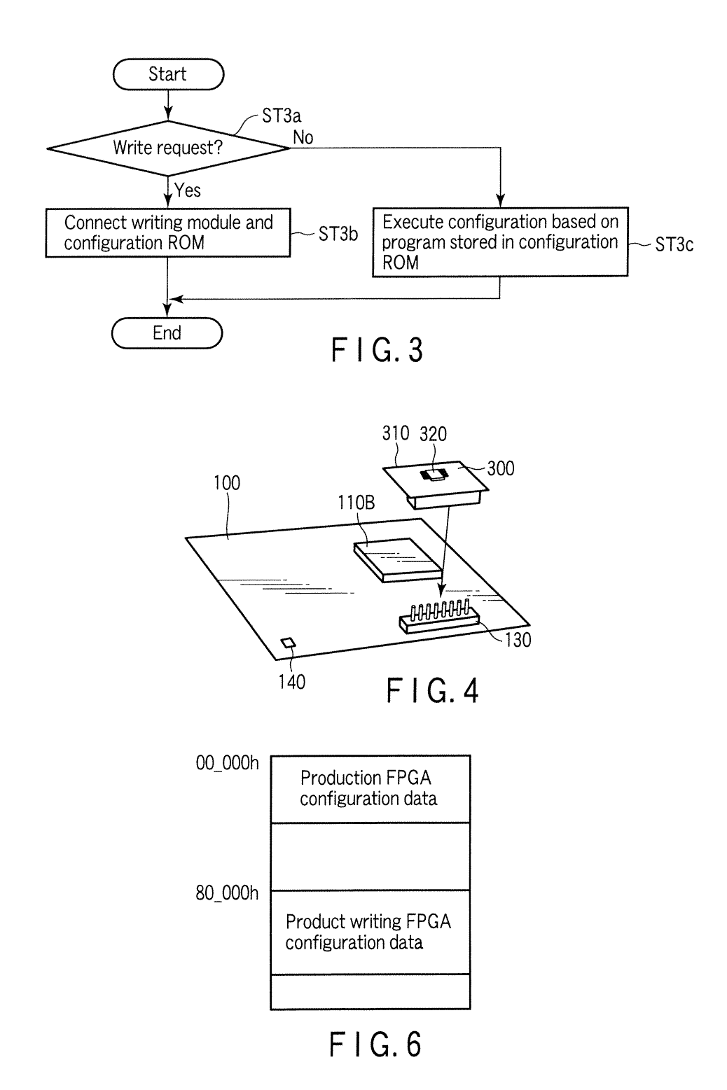

FIG. 4 is a perspective view showing an example of connecting a configuration ROM board for production 300 of production equipment to a connector 130 of a board 100.

In the configuration ROM board for production 300, a ROM 320 such as SPI-FLASH is mounted on a board 310. The board 100 is provided with a light emitting diode (LED) 140 for informing an external device that a program is being written or has been written to the configuration ROM 120. Here, the LED 140 is lit in blue when a program is being written, and is lit in red when a program has been written.

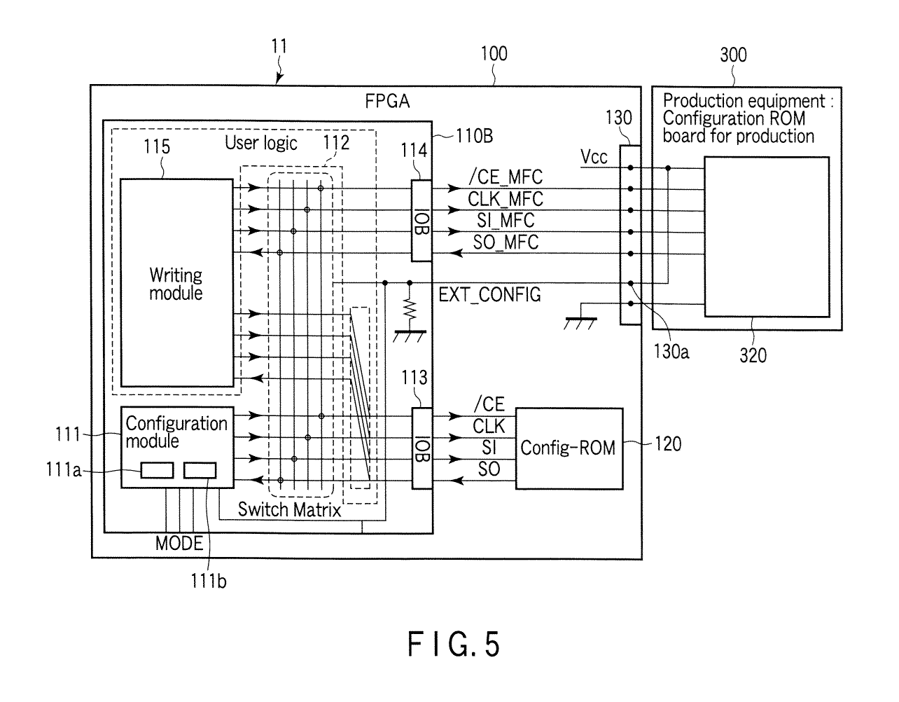

FIG. 5 is a block diagram of a concrete configuration of a time switch 11 according to the second embodiment. In FIG. 5, the same components as those in FIG. 2 are given the same reference numbers, and detailed explanation thereof is omitted.

In the second embodiment, a writing module 115 is provided in an FPGA 110B. When the matrix switch 112 directly connects the configuration ROM board 300 to the configuration ROM 120 at power-on, the writing module 115 reads a program from the ROM 320 of the configuration ROM board 300 corresponding to a first address, and reads the program into the configuration ROM 120.

Next, the operation of the above configuration is explained.

When a not-shown power switch is turned on and a not-shown power supply module supplies power, the configuration module 111 determines whether a write request is sent from the configuration ROM board 300 connected to the connector 130. Here, when the configuration ROM board 300 is connected to the external configuration terminal 130a of the connector 130, and the power switch is turned on, a signal responding to the write request is sent from the external configuration terminal 130a to the configuration module 111.

When a signal responding to the write request is received from the configuration ROM board 300, the configuration module 111 controls the matrix switch 112 to make connect between the configuration ROM board 300 and writing module 115, and between the writing module 115 and configuration ROM 120.

On the other hand, when the configuration ROM board 300 is not detected via the external configuration terminal 130a after the power switch is turned on (No), the configuration module 111 determines that the connector 130 has been connected to the PCM highway 15 or control bus, for example, and executes configuration based on a program stored in the configuration ROM 120, thereby forming the time switch (block ST3c).

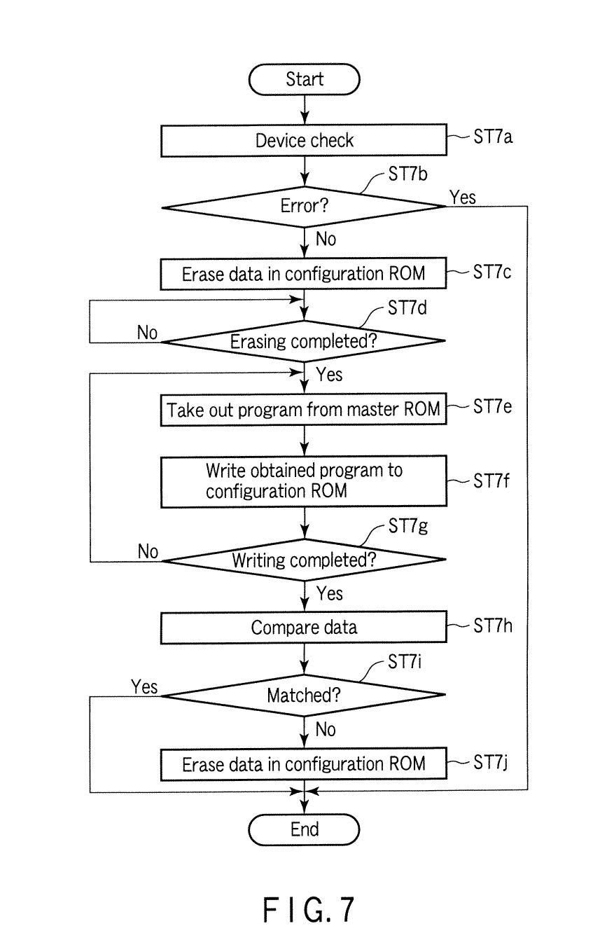

When connection is made between the configuration ROM board 300 and writing module 115, and between the writing module 115 and configuration ROM 120, the writing module 115 executes the control procedures shown in FIG. 7.

First, the writing circuit 115 makes a device check for the ROM 320 of the configuration ROM board 300, and the configuration ROM 120 (block ST7a), and determines whether the device is correct (block ST7b). Here, for example, when the device ID assigned to the configuration ROM 120 is not a specified device ID (Yes), the writing module 115 terminates the program writing.

On the other hand, when the device ID assigned to the configuration ROM 120 is a specified device ID (No), the writing module 115 erases all data remaining in the configuration ROM 120 (block ST7c). When the data erasing is completed, the writing module 115 shifts the state from block ST7d to block ST7e, sends a read command specifying a higher-order bit of address to (00) to the ROM 320 on the configuration ROM board 300, and reads a program from the ROM 320 by 256 bytes, for example. The writing module 115 sends a write command specifying a higher-order bit to (80) to the configuration ROM 120, and transfers a program it to the configuration ROM 120 and writes it there (block ST7f).

Then, the writing circuit 115 determines whether all programs (e.g., 4M bits) have been read (block ST7g), and repeats the operation of block ST7g until all programs are read.

When the program reading is completed (Yes), the writing module 115 sends again the command specifying a higher-order bit to (80) to the configuration ROM 120, and reads the written program. The writing module 115 sends again the command specifying a higher-order bit to (00) to the ROM 320 on the configuration ROM board 300, and reads the program from the ROM 320, compares the data (block ST7h), and determines whether the data is matched (block ST7i). When the data is matched (Yes), the writing module 115 terminates the operation. When the data is not matched, the writing module 115 erases all programs written in the configuration ROM 120 (block ST7j).

When the above operation is completed, the writing module 115 causes the LED 140 to indicate that the writing is completed. In this case, the LED 140 is lit in red.

In this state, a maintenance personnel of production equipment turns off the not-shown power switch, and removes the configuration ROM board 300 from the connector 130. When the power switch is turned on next time, the configuration module 111 forms the time switch 11 by executing configuration based on the program stored in the configuration ROM 120.

As described above, in the second embodiment, the writing module 115 of the FPGA 110B writes a program to the configuration ROM 120.

Therefore, the production equipment can be simplified by the configuration ROM board 300 provided with the ROM 320, and this contributes to reduce the cost of production equipment.

### Third Embodiment

In a third embodiment, in addition to reduce the cost of production equipment by providing a writing module for a configuration ROM in an FPGA, an external configuration terminal of a connector becomes unnecessary by checking whether a header for instructing to write a program obtained from a ROM of production equipment.

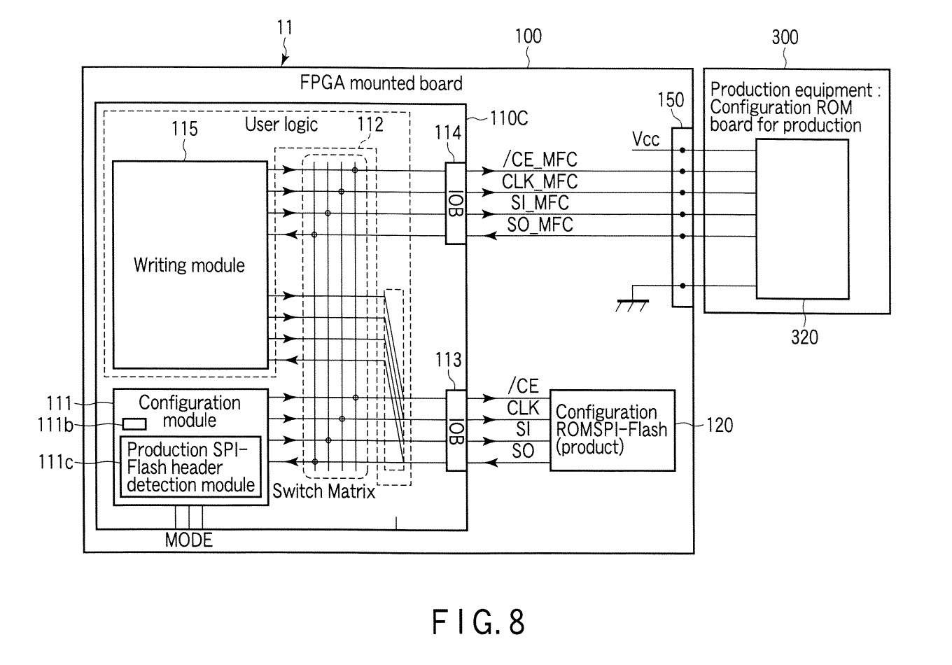

FIG. 8 is a block diagram of a concrete configuration of a time switch 11 according to the third embodiment. In FIG. 8, the same components as those in FIG. 5 are given the same reference numbers, and detailed explanation thereof is omitted.

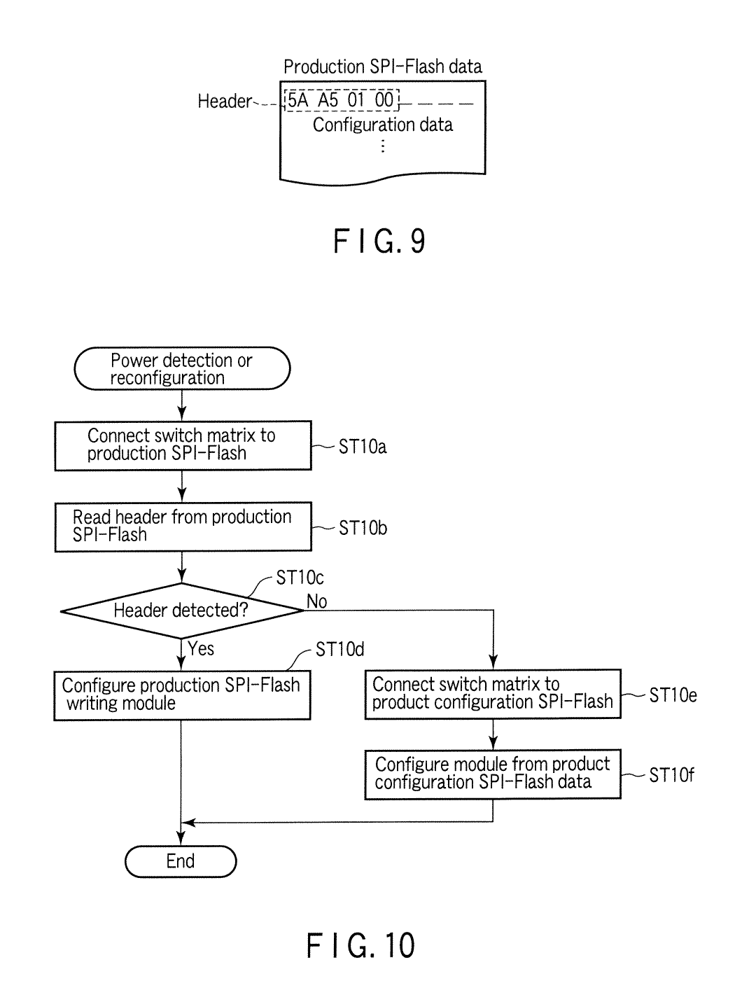

In the third embodiment, a header detection module 111c is provided in a configuration module 111. The header detection module 111c detects whether header data for instructing to write a program stored in the ROM 320 on the configuration ROM board 300 is added. The header data consists of a code (5A A5 01 00) identifiable by the configuration module 111, as shown in FIG. 9.

A connector 150 for connecting the configuration ROM board 300 is formed by removing the external configuration terminal 130 from the connector 130.

When the header detection module 111c detects header data, the controller 111b controls the matrix switch 112 to make connection between the configuration ROM board 300 and writing module 115, and between the writing module 115 and configuration ROM 120.

Next, the operation of the above configuration is explained.

FIG. 10 is a flowchart of control procedures of the configuration module 111 when writing a program to the configuration ROM 12.

When a not-shown power switch is turned on, and a not-shown power supply module supplies power, the configuration module 111 controls the matrix switch 112 to connect the ROM 320 on the configuration ROM board 300 connected to the connector 150 (block ST10a). The configuration module 111 reads header data into a program stored in the ROM 320 (block ST10b), and determines whether the read header data consists of an identifiable code (block ST10c).

When the header data is an identifiable code (Yes), the configuration module 111 controls the matrix switch 112 to make connection between the configuration ROM board 300 and writing module 115, and between the writing module 115 and configuration ROM 120 (block ST10d).

On the other hand, when the header data is a nonidentifiable code, or the header data is not added to a program stored in the ROM320 (No), the configuration module 111 controls the matrix switch to connect the configuration ROM 120 (block ST10e), and executes configuration based on a program stored in the configuration ROM 120, thereby forming the time switch (block ST10f).

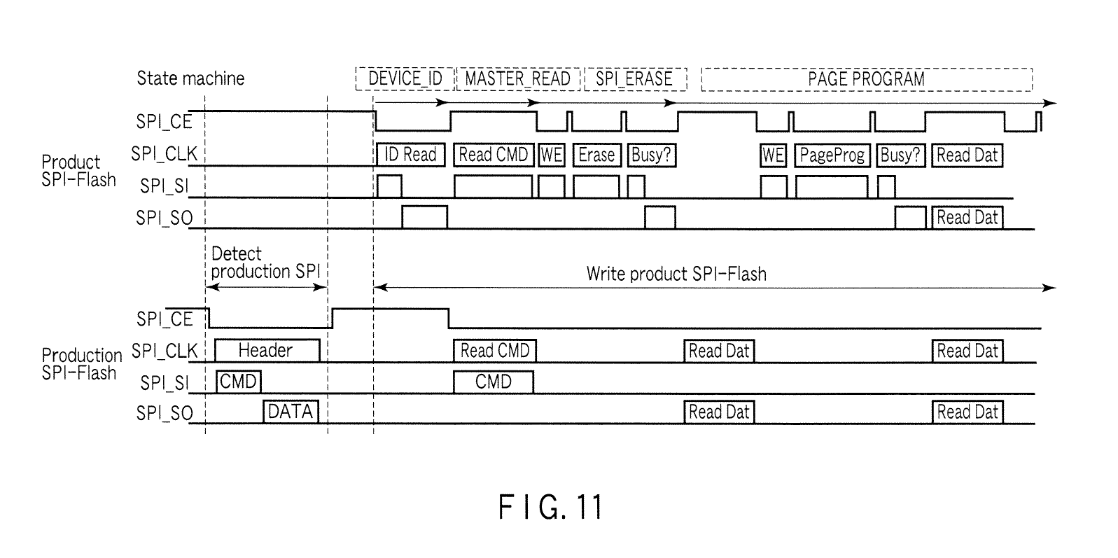

In the above block ST10d, the writing module 115 writes a program at the operation timing shown in FIG. 11.

First, the writing module 115 sends an enable signal (SPI CE) at a low level to the ROM 320 on the configuration ROM board 300, sends a header data read command via a data input line (SPI SI), and reads header data from the ROM 320. Receiving the header data, the writing module 115 sends the enable signal changed from a low level to a high level to the ROM 320.

While receiving the header data, the writing module 115 sends an enable signal at a high level to the configuration ROM 120. An enable signal at a low level indicates that the writing module 115 can read data from a ROM, and an enable signal at a high level indicates that the writing module 115 cannot read data from a ROM. When a command is sent to a ROM, the writing module 115 can send a command at the timing when the level of an enable signal is changed from high level to low level. When an enable signal is kept at a low level, the writing module 115 cannot send the next command to a ROM.

The writing module 115 sends an ID read command (ID Read) to the configuration ROM 120, makes a device check by reading the device ID assigned to the configuration ROM 120, and determines whether the device is correct. Here, when the device ID assigned to the configuration ROM 120 is not a specified device IS, for example, the writing module 115 sends an enable signal kept at a low level to the configuration ROM 120, and terminates the program writing operation.

On the other hand, when the device ID assigned to the configuration ROM 120 is a specified device ID, the writing module 115 sends a write command (WE) to the configuration ROM 120, writes test data, and sends an erase command (Erase) and erases all remaining data. Then, the writing module 115 sends a completion notice command (Busy) to the configuration ROM 120, and when data indicating completion is returned from the configuration ROM 120 in response to the command, the writing module 115 changes the level of an enable signal from low to high level. When the operation is not completed, the writing module 115 keeps the enable signal at a low level.

The writing module 115 sends a read command (Read CMD) specifying a higher-order bit of address to (00) to the ROM 320 on the configuration ROM board 300, and reads a program from the ROM 320 by 256 bytes, for example. The writing module 115 sends a write command specifying a higher-order bit to (80) to the configuration ROM 120, and transfers a program to the configuration ROM 120 and writes it there.

Then, the writing module 115 inquires of the configuration ROM 120 about whether all programs (e.g., 256×1024 bytes) have been read. When the program reading is not completed, the writing module 115 keeps the enable signal at a low level.

When the program reading is completed, the writing module 115 sends again the command specifying a higher-order bit to (80) to the configuration ROM 120, and reads the written program. The writing module 115 sends again the command specifying a higher-order bit to (00) to the ROM 320 on the configuration ROM board 300, and reads the program from the ROM 320, compares the data, and determines whether the data is matched. When the data is matched, the writing module 115 terminates the operation. When the data is not matched, the writing module 115 erases all programs written in the configuration ROM 120.

As described above, in the third embodiment, as header data added to a program is used, only when the header data is detected, the configuration ROM board 300 is determined to be a correct device used for production, and a program stored in the ROM 320 of the configuration ROM board 300 is written to the configuration ROM 120.

Therefore, by a simple procedure of detecting header data, a program stored in the ROM 320 on the configuration ROM board 300 can be automatically written to the configuration ROM 120 at high speed.

### Other Embodiments

Other embodiments are not limited to the embodiments described hereinbefore. For example, a matrix switch is used in the embodiments described hereinbefore. However, a matrix switch may be replaced by a means of forming a route for connecting a configuration ROM to a writing module or ROM of production equipment.

In the third embodiment, an example of connecting a configuration ROM board is described. It is allowed to connect a writing module such as a personal computer. In each of the above embodiments, a communication module other than a time switch may be used. A program is written to a configuration ROM at production in the above embodiments. It is allowed to change a program previously written to a configuration ROM. For example, when a time switch is changed to an extension interface module, all that is needed is to connect a writing module to a connector, and to simply write a program for realizing an extension interface module, over a configuration ROM. When a time switch is upgraded, all that is needed is to connect a writing module to a connector, and to write an upgrade program over a configuration ROM.

Moreover, the configuration of a communication apparatus, the configuration of a telephone switching system incorporating the communication apparatus, and the control procedures of writing a program to a configuration ROM can be modified in various forms.

Therefore, according to each of the above embodiments, electronic equipment is provided only a connection terminal for electronic equipment, a communication processor, and storage, and has a program to be written to storage. When the electronic equipment is connected to a connection terminal, a terminal for writing a program to storage is shared by an already provided connection terminal, by executing the operation to write the program held by the electronic equipment to the storage. Therefore, it is unnecessary to provide an exclusive writing terminal in addition to the connection terminal. This provides a simple low-cost FPGA configured to write a program to storage at a high speed with the less number of man-hours.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus comprising:
a communicating module configured to operate based on a program stored in storage, and to executes communication with electronic equipment connected to a connection terminal;
a detecting module configured to detect that electronic equipment is connected to the connection terminal, at power-on, wherein the electronic equipment includes a program to be written to the storage; and
a controlling module configured to executes an operation of writing a program possessed by the electronic equipment to the storage, when the electronic equipment connected to the connection terminal is detected.

2. The communication apparatus of claim 1, wherein the detecting module detects the electronic equipment including a program, by receiving an instruction signal to write a program from the electronic equipment to the storage via one of signal pins provided in the connection terminal.

3. The communication apparatus of claim 1, further comprising a switching module configured to selectively make connection between the communicating module and the storage, and between the electronic equipment and the storage,
wherein the controlling module controls the switching module to make connection between the electronic equipment and storage.

4. The communication apparatus of claim 1, further comprising a writing module configured to write a program to the storage,
wherein the controlling module causes the writing module to obtain the program from the electronic equipment, and writes the program to the storage, when the detecting module detects the electronic equipment including the program.

5. The communication apparatus of claim 4, wherein the detecting module detects whether a header is added to a program possessed by the electric equipment, wherein the header is instruct to write the program, and
the controlling module causes the writing module to obtain the program from the electronic equipment, and writes the program to the storage, when the detecting module detects the header.

6. A programmable device provided in a communication apparatus, in which a communication processor operates based on a program stored in storage, and executes communication with electronic equipment connected to a connection terminal of the communication apparatus, the programmable device comprising:
a detecting module configured to detect that electronic equipment is connected to the connection terminal, at power-on, wherein the electronic equipment includes a program to be written to the storage; and
a controlling module configured to execute an operation of writing a program possessed by the electronic equipment to the storage, when the electronic equipment connected to the connection terminal is detected.

7. The program device of claim 6, wherein the detecting module detects the electronic equipment including a program, by receiving an instruction signal to write a program from the electronic equipment to the storage via one of signal pins provided in the connection terminal.

8. The program device of claim 6, further comprising a switching module configured to selectively make connection between the communication processor and storage, and between the electronic equipment and storage,
wherein the controlling module controls the switching module to make connection between the electronic equipment and storage.

9. The program device of claim 6, further comprising a writing module configured to write a program to the storage,
wherein the controlling module causes the writing module to obtain the program from the electronic equipment, and writes the program to the storage, when the detecting module detects the electronic equipment including the program.

10. The program device of claim 9, wherein the detecting module detects whether a header is added to a program possessed by the electric equipment, wherein the header is instruct to write the program, and
the controlling module causes the writing module to obtain the program from the electronic equipment, and write the program to the storage, when the detecting module detects the header.

11. A method of controlling program writing used in a communication apparatus in which a communication processor operates based on a program stored in storage, and executes an operation of communicating with electronic equipment connected to a connection terminal, the method of controlling program writing comprising:
detecting that electronic equipment is connected to the connection terminal, at power-on, wherein the electronic equipment including a program to be written to the storage; and
executing an operation of writing a program possessed by the electronic equipment to the storage, when the electronic equipment connected to the connection terminal is detected.

12. The method of claim 11, wherein the detecting comprises detecting the electronic equipment including a program, by receiving an instruction signal to write a program from the electronic equipment to the storage via one of signal pins provided in the connection terminal.

13. The method of claim 11, further comprising selectively connecting between the communication processor and storage, and between the electronic equipment and storage,
wherein the executing comprises controlling the connection between the electronic equipment and storage.

14. The method of claim 11, further comprising writing a program to the storage,
wherein the executing comprises obtaining the program from the electronic equipment, and writing the program to the storage, when the electronic equipment connected to the connection terminal is detected.

15. The method of claim 14, wherein the detecting comprises detecting whether a header is added to a program possessed by the electric equipment, wherein the header is instruct to write the program, and
the executing comprises obtaining the program from the electronic equipment, and writing the program to the storage, when the header is detected.
